(19) United States
(12) Patent Application Publication
(10) Pub. No.: US 2022/0051205 A1
(43) Pub. Date: Feb. 17, 2022

(54) METHOD AND SYSTEM FOR DISTRIBUTING SUPPORT FUND USING SUBSTITUTE PAYMENT PROCESSING SERVER

(71) Applicant: Spinor Media Inc., Seoul (KR)

(72) Inventor: Zae Young KIM, Seoul (KR)

(73) Assignee: Spinor Media Inc., Seoul (KR)

(21) Appl. No.: 17/336,438

(22) Filed: Jun. 2, 2021

(30) Foreign Application Priority Data
Aug. 13, 2020 (KR) 10-2020-0101462

(51) Int. Cl. G06Q 20/10; G06Q 20/02

(52) U.S. Cl. CPC G06Q 20/102; G06Q 20/108; G06Q 20/027

(57) ABSTRACT

Provided is a substitute support fund distribution system using a substitute payment processing server. The substitute support fund distribution system includes a payment request terminal configured to transmit information related to a seller and payment information related to a payer, a payment and payment gateway server configured to receive a payment request from the payment request terminal and proceed with payment or remittance processing, and the substitute payment processing server configured to communicate with the payment and payment gateway server, and transmit information about a support fund related to the payer to the payment and payment gateway server.

### CROSS REFERENCE TO RELATED APPLICATIONS

This application claims priority to Korean Patent Application No. 10-2020-0101462 filed on Aug. 13, 2020, the entire contents of which are herein incorporated by reference.

### TECHNICAL FIELD

The present disclosure relates to a method and system for distributing a support fund using a substitute payment processing server, and particularly to, a method of automatically distributing a support fund in conjunction with a payment server and a payment gateway server using a substitute payment processing server for processing a support fund payment of the government or a local government.

### BACKGROUND ART

A payment method developed in the past wired communication technology era is a seller payment method, in which a buyer first specified the payment method and transmitted buyer information to a seller. In this case, there are problems that the risk of exposure of the buyer information increases, and inconsistency between a payment information flow and a cash flow occurs compared to a normal transaction.

A reverse payment method that solves these problems is a method that has evolved into a wireless mobile payment method due to the recent development of wireless communication technology and popularization of mobile devices, and transmits seller information to the buyer. At this time, the risk of exposure of the buyer information is reduced, and the payment information flow and the cash flow coincide with the normal transaction, and, that is, after the buyer receives and confirms payment related information, the money is executed.

In the case of such reverse payment, there occurs a case where at least a portion of a payment money or a purchase money must be raised from a substitute payer, such as when at least a part of a purchase amount is supported or subsidized through the government or a local government. Such a substitute payment may not be conveniently solved through a single payment using a payment gateway system such as the current value added network (VAN) company, a payment gate (PG), etc.

In addition, each local government has recently made efforts to revitalize the local economy by activating consumption in a region through issuance of local currency, and such local currency is provided in the form of a prepaid card or a check card. In order to activate the use of local currency, a reward method exists. For example, Gyeonggi local currency uses a method of charging a rechargeable prepaid card, for example, a method of giving a maximum of 10% of a charging amount as a reward. In this method, because the charged amount is given to an account of a business provider, problems may arise if there is a business or financial problem of the business provider. There is a second method of purchasing gift certificates, for example, of purchasing local gift certificates at a 10% discount. In this case, there may be a problem of mass purchase of certain individuals or companies, and there may be a large gap between the time of purchase of a gift certificate and the time of an actual sale, making it difficult to achieve a great effect when it is necessary to revitalize the local economy.

As described above, in the conventional system, due to the limitations of government or local finances, it is not easy to provide stably a support fund due to a problem of a user concentration phenomenon when a subsidy ratio is high or due to a problem of a low user participation when the subsidy ratio is low and it is difficult to operate efficiently and stably a limited support fund budget. Accordingly, there is a need for a new method and system structure for implementing a support fund automatic distribution system in conjunction with a payment gateway server using a substitute payment processing server for a substitute payment of the government or a local government.

### PRIOR ART DOCUMENT

### Patent Literature 1

Korean Patent No. 10-1192826

### SUMMARY

### Technical Problem

The present disclosure is directed to providing a method and system for conveniently processing a substitute payment of a support fund of the government or a local government in conjunction with a payment server and a payment gateway server and a substitute payment processing server.

The present disclosure is also directed to providing an automatic support fund distribution system capable of stably distributing and providing a limited amount of support fund budget over the entire period.

The present disclosure is also directed to providing a support distribution method and system using a substitute payment capable of solving a problem of a user concentration phenomenon when a subsidy ratio is high or a problem of a low user participation when the subsidy ratio is low.

The present disclosure is also directed to providing an automatic support fund distribution system capable of determining an appropriate support fund ratio based on big data.

The present disclosure is also directed to providing a substitute payment method and system capable of addressing welfare blind spots or information gaps and enabling active administrative services from the perspective of consumers by implementing the substitute payment system that is utilizable in the government or a related local government when providing subsidy or local currency to local residents, socially vulnerable class, welfare support targets of local governments, disaster victims in a disaster situation, etc.

The present disclosure is also directed to providing a system that enables a support fund-based substitute payment by utilizing a network between a payment server and a payment gateway server (a VAN company, a PG company, a card company, a financial company server, etc.)

The problems to be solved of the present disclosure are not limited to the description mentioned above, and other technical problems that are not mentioned will be clearly understood by those skilled in the art from the following description.

### Technical Solution

In one aspect of the present disclosure, there is provided a substitute support fund distribution system using a substitute payment processing server including a payment request terminal configured to transmit information related to a seller and payment information related to a payer; a payment and payment gateway server configured to receive a payment request from the payment request terminal and proceed with payment or remittance processing; and the substitute payment processing server configured to communicate with the payment and payment gateway server, and transmit information about a support fund related to the payer to the payment and payment gateway server.

The payment and payment gateway server may include at least one of a VAN company server, a PG company server, a card company server, and a financial company server.

The substitute payment processing server may include a support fund automatic determination unit configured to determine a support fund ratio to a payment amount.

The support fund automatic determination unit may be configured to determine the support fund ratio based on a support fund budget and a usage amount of the support fund.

The support fund automatic determination unit may be configured to determine whether to increase, decrease, or maintain the support fund ratio by comparing a usage amount of the support fund during a predetermined period with a support fund budget during a period.

The predetermined period may be settable on a daily, weekly, or monthly basis, and may be changeable according to an exhaustion ratio of the usage amount of the support fund to the support fund budget.

The support fund automatic determination unit may be configured to set a ratio of accumulation points to be provided to the payer based on a payment amount in addition to the support fund.

The substitute support fund distribution system may further include: a substitute payment information processing unit configured to determine whether a substitute payment condition is satisfied based on payment information received from the payment and payment gateway server, and to determine a substitute payment ratio based on the support fund ratio determined by the support fund automatic determination unit.

Whether the substitute payment condition is satisfied may be determined based on at least one of a support fund limit, a business type of the seller, purchase details, and a payment amount.

In another aspect of the present disclosure, there is provided a substitute support fund distribution method using a substitute payment processing server including transmitting, by a payment request terminal, information related to a seller and payment information related to a payer; receiving, by a payment and payment gateway server, a payment request from the payment request terminal and proceeding, by the payment and payment gateway server, with payment or remittance processing; and communicating, by the substitute payment processing server, with the payment and payment gateway server, and transmitting, by the substitute payment processing server, information about a support fund related to the payer to the payment and payment gateway server.

The substitute support fund distribution method may further include: determining, by the substitute payment processing server, a support fund ratio to a payment amount.

The support fund ratio may be determined based on a support fund budget and a usage amount of the support fund.

The substitute support fund distribution method may further include: determining, by the substitute payment processing server, whether to increase, decrease, or maintain the support fund ratio by comparing a usage amount of the support fund during a predetermined period with a support fund budget during the period.

The predetermined period may be settable on a daily, weekly, or monthly basis, and may be changeable according to an exhaustion ratio of the usage amount of the support fund to the support fund budget.

The substitute support fund distribution method may further include: setting a ratio of accumulation points to be provided to the payer based on a payment amount in addition to the support fund.

The substitute support fund distribution method may further include: determining whether a substitute payment condition is satisfied based on received payment information, and a substitute payment ratio is determined based on the determined support fund ratio.

### Advantageous Effects

The present disclosure may provide a method and system for conveniently processing a substitute payment of a support fund of the government or a local government in conjunction with a payment server and a payment gateway server and a substitute payment processing server.

The present disclosure may also provide an automatic support fund distribution system capable of stably distributing and providing a limited amount of support fund budget over the entire period.

The present disclosure may also provide a support distribution method and system using a substitute payment capable of solving a problem of a user concentration phenomenon when a subsidy ratio is high or a problem of a low user participation when the subsidy ratio is low.

The present disclosure may also provide an automatic support fund distribution system capable of determining an appropriate support fund ratio based on big data.

The present disclosure may also provide a substitute payment method and system capable of addressing welfare blind spots or information gaps and enabling active administrative services from the perspective of consumers by implementing the substitute payment system that is utilizable in the government or a related local government when providing subsidy or local currency to local residents, socially vulnerable class, welfare support targets of local governments, disaster victims in a disaster situation, etc.

The present disclosure may also provide a system that enables a support fund-based substitute payment by utilizing a network between a payment server and a payment gateway server (a VAN company, a PG company, a card company, a financial company server, etc.)

The effects of the present disclosure are not limited to the description mentioned above, and other effects not mentioned will be clearly understood by those skilled in the art from the following description.

### BRIEF DESCRIPTION OF DRAWINGS

FIG. 1 is a conceptual diagram illustrating a conventional general payment gateway service.

FIGS. 2A and 2B are conceptual diagrams illustrating a method of distributing a support fund using a substitute payment processing server according to an embodiment of the present disclosure.

FIG. 3 is a block diagram illustrating the configuration of a support fund distribution system using a substitute payment processing server according to an embodiment of the present disclosure.

FIG. 4 is a block diagram illustrating a configuration of a substitute payment processing server of a support fund distribution system according to an embodiment of the present disclosure.

FIGS. 5A and 5B are example diagrams for explaining a method of determining a support fund ratio in a support fund distribution system according to an embodiment of the present disclosure.

FIG. 6 is a flowchart illustrating a method of distributing a support fund using a substitute payment processing server according to an embodiment of the present disclosure.

### DETAILED DESCRIPTION OF DRAWINGS

The terms used herein are for the purpose of describing embodiments and are not intended to limit the present disclosure. As used herein, the singular forms also are intended to include the plural forms as well, unless the context clearly indicates otherwise.

It will be further understood that the terms “comprises” and/or “comprising,” when used in this specification, specify the presence of stated elements, steps, operations, and/or components, but do not preclude the presence or addition of one or more other elements, steps, operations, and/or components.

In addition, the terms including ordinals such as “first”, “second”, etc. may be used to describe various components, but the components are not limited to these terms. The terms are used only for the purpose of distinguishing one component from another. In addition, in describing the present disclosure, when it is determined that a detailed description of a related known technology may obscure the spirit of the present disclosure, a detailed description thereof will be omitted.

In addition, configuration units shown in the embodiments of the present disclosure are independently illustrated to represent different characteristic functions, and does not mean that each configuration unit includes separate hardware or a single software configuration unit. That is, each configuration unit is listed and described as a respective configuration unit for convenience of description, and at least two configuration units of each configuration unit are combined to form a single configuration unit, or one configuration unit may be divided into a plurality of configuration units to perform a function. Integrated embodiments and separate embodiments of each of the configuration units are also included in the scope of the present disclosure unless departing from the spirit of the present disclosure.

Hereinafter, embodiments of the present disclosure will be described in detail with reference to the accompanying drawings. The configuration of the present disclosure and its effect will be clearly understood through the detailed description below.

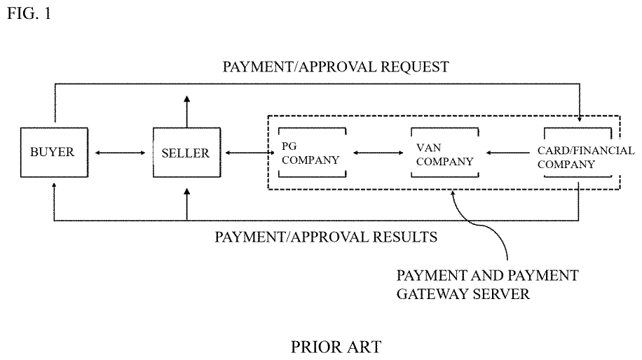

FIG. 1 is a conceptual diagram illustrating a conventional general payment gateway service.

Referring to FIG. 1, when a buyer performs card payment through a seller such as an online or offline shopping mall, payment/approval is requested through a server of a payment agency such as a payment gateway (PG) company and a value added network (VAN) company, and servers of a card company and a financial company, and when payment/approval is processed, results of payment/approval may be transmitted to the buyer and the seller.

Here, the PG company is in charge of an electronic payment agency that enables a safe and convenient payment using other online payment methods such as a credit card, an account transfer, a mobile phone payment, an ARS payment, etc. and the VAN company provides a communication network for an offline card payment, and is a business operator in which when a card is used in online and offline stores, a VAN that connects communication between a card company and a store operates, and establishes a network between a financial institution such as the card company and an affiliate store to relay approval according to use of a card and do business such as purchase of slips on behalf of the financial institution.

As described above, a payment processing process proceeds in conjunction with the payment gateway servers of the PG and VAN companies and the payment servers of the card company and the financial institution. The servers operated by these companies herein will be integrated and defined as a “payment and payment gateway server”.

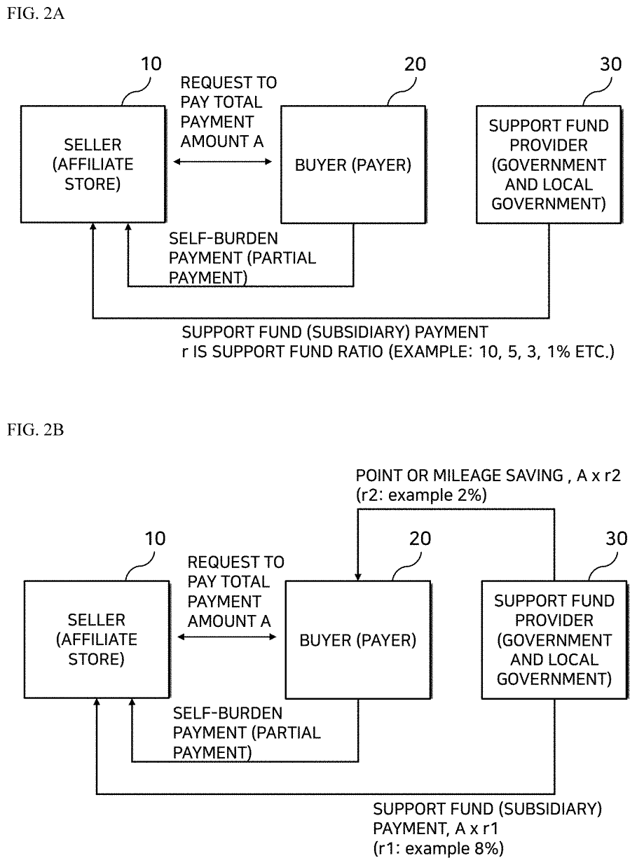

FIGS. 2A and 2B are conceptual diagrams illustrating a method of distributing a support fund using a substitute payment processing server according to an embodiment of the present disclosure.

Referring to FIG. 2A, a method of processing a substitute payment on a portion of the total payment amount as a support fund (or a subsidy) according to an embodiment of the present disclosure will be described.

A purchaser (or a payer) 20 may perform a payment to a seller (or an affiliate store) 10 in the same manner as a general card payment, and may perform a payment request for KRW A which is the total payment amount. At this time, a support fund ratio r of a support fund provider (the government or a local government) 30 may be determined as, for example, 10%, 5%, 3%, 1%, etc. through the substitute payment processing server connected to a payment server or a payment gateway server and may vary depending on a time or a period. According to the support fund ratio r determined as described above, the support fund provider 30 may burden a substitute payment as much as an amount of A×r, and the purchaser 20 may process a self-burden payment on only the remaining amount. The purchaser 20 that directly generates a payment may be referred to as a payer, and the support fund provider 30 may be referred to as a substitute payer paying at least partial amount for the purchaser 20.

According to the method of distributing the support fund using the substitute payment, because the subsidy ratio may be adaptively changed according to a situation of exhaustion of a subsidy budget, the government and local government may stably distribute and provide the support money during a budget period when providing the support money, the subsidy, or local currency for a welfare support and a disaster support, thereby providing the support money more efficiently and stably.

FIG. 2B shows a method of processing the substitute payment on a portion of the total payment amount as the support fund and additionally accumulating points or mileage to a purchaser (a payer) according to another embodiment of the present disclosure.

Referring to FIG. 2B, in r1 which is a support fund ratio in a total payment amount A, the substitute payment may be applied by applying, for example, 8%, and in r2 which is an additional point or mileage accumulation ratio, a point accumulation may be provided instead of a substitute payment discount for 2% of the total payment amount A by applying, for example, 2%.

In this case, the accumulated points or mileage are not used at the time of this payment, and may be used at the next payment or when certain conditions are met, thereby having an effect of delaying an execution time of the support fund without immediately executing the support fund, which may be helpful in an efficient distribution of the support fund. In addition, it is possible to obtain an effect of generating customer loyalty through points or mileage to buyers such as tourists, leading to revisiting or repurchasing.

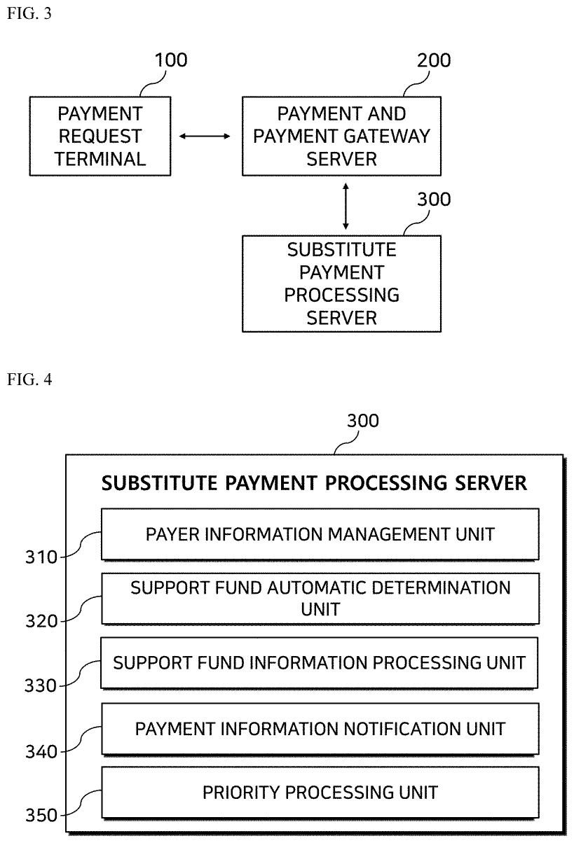

FIG. 3 is a block diagram illustrating the configuration of a support fund distribution system using a substitute payment processing server according to an embodiment of the present disclosure.

The support fund distribution system according to an embodiment of the present disclosure may include a payment request terminal 100, a payment and payment gateway server 200, and a substitute payment processing server 300, and additional components may be added as needed.

The payment request terminal 100 is, for example, a seller (an affiliate store) terminal or a buyer terminal for selling goods or services to a buyer (a payer) and processing payment, and may be configured to transmit information related to the seller and payment information related to the payer to payment and payment gateway server 200 when payment of the buyer is performed. The information related to the seller may include information such as identification information of the payment, information about a type of business of the seller, sales details and a collection account, and the payment information related to the payer may include a payment amount, purchase details, and a payment money. In addition, the payment information related to the payer may include identification information for identifying the payer. Here, the identification information of the payer may include at least one of a social security number of the payer, a mobile phone number, and a card number, and the substitute payment processing server 300 may receive the identification information of the payer and obtain and process information related to a support fund of the payer.

For example, the seller terminal includes a communication unit to be connected to and communicate with the payment and payment gateway server 200, and a substitute payment processing server 300 through a wired/wireless communication network, and may be one of, for example, a kiosk, POS terminal, a smart phone, a tablet computer, a desktop computer, a laptop computer, a notebook, a workstation, a server computer, a personal digital assistant (PDA), a portable computer, a wireless phone, a mobile phone, an e-book, a portable multimedia player (PMP), a portable game console, a navigation device, a black box, a digital camera, a television, a wearable device, a voice recognition speaker, a smart speaker, an artificial intelligence (AI) speaker, but is not limited thereto.

In addition, in the case of payment using, for example, a QR code, a payment request may be transmitted to the payment and payment gateway server 200 by the buyer terminal. For example, the buyer terminal may include various forms like the seller terminal such as a smartphone, a tablet computer, a desktop computer, and a notebook.

The payment and payment gateway server 200 may include payment servers that process a payment in a variety of methods, such as payment gateway servers of the PG company and the VAN company, a payment server of a credit card company, a payment server of a financial institution, a payment server of an insurance institution, a payment server of a telecommunication company, a point payment server, and a simple payment server. The payment and payment gateway server 200 may be configured to receive a payment request from the seller terminal or the buyer terminal, and to perform payment or remittance processing.

The substitute payment processing server 300 may be configured to operate in conjunction while communicating with the payment and payment gateway server 200, receive the information related to the payment from the payment and payment gateway server 200, and transmit substitute payment information related to the support fund of the payer to the payment and payment gateway server 200.

In addition, the substitute payment processing server 300 may be configured to identify the payer through the identification information of the payer based on a card number of the payer, a social security number, or a phone number, set information related to the support fund such as a support fund ratio and limit of the payer, and manage the information related to the support fund.

For example, a support fund provider, which is a subject that pays at least a portion of the payment amount through the support fund through the substitute payment processing server 300 may designate nation such as the government, a local government, an association, residents of the region, socially vulnerable class, welfare support targets, or disaster victims, etc. to constitute an institution, a foundation, a donation group, etc. that perform a substitute payment.

In addition, the substitute payment processing server 300 may determine whether a substitute payment condition is satisfied such as a support fund support condition is satisfied based on the payment information received from the payment and payment gateway server 200, and when the substitute payment condition is satisfied, determine a support fund payment ratio based on a previously set condition. For example, when a support fund substitute payment condition is satisfied, if it is previously set to support 10% of the total payment amount, a split payment may be processed by dividing the total payment amount at a ratio of 90:10 between a payer A and a substitute payer B.

In addition, the substitute payment processing server 300 may determine whether a substitute payment condition in which a support fund limit of the payer, a business type of the seller, purchase details, and the information related to the payment money are previously set is satisfied based on the payment information received from the payment and payment gateway server 200 and, only when the substitute payment condition is satisfied, and perform the substitute payment.

For example, through the substitute payment processing server 300, a substitute payment period of the substitute payer, a payment amount per case or a total payment amount within the payment period, allowable purchase details, an allowable seller, a business type of the allowable seller, etc., may be set, and condition setting of the substitute payment may be previously processed by acceptance of the substitute payer. In addition, the substitute payment may not be processed if there is no support fund limit balance by comparing the support fund limit balance of the purchaser 20 and the payment money, or if the support fund limit balance of the purchaser 20 is smaller than the total support fund amount according to a support fund ratio with respect to the payment amount, support fund processing may be performed only on the support fund limit balance.

FIG. 4 is a block diagram illustrating a configuration of a substitute payment processing server of a support fund distribution system according to an embodiment of the present disclosure.

The substitute payment processing server 300 may include, for example, a payer information management unit 310, a support fund automatic determination unit 320, a support fund information processing unit 330, a payment information notification unit 340, a priority processing unit 350, and the like. These components may include a program or a program module that may be executed by one or more processors. Here, the program or program modules may be configured in the form of an operating system, an application program, or a program, and may be physically stored on various types of storage devices that are widely used. Such program or program modules may include various forms for performing one or more routines, subroutines, programs, objects, components, instructions, a data structure, and a specific task or for executing a specific data type, but is not limited to these types.

First, the substitute payment processing server 300 may include the payer information management unit 310 configured to identify a payer through identification information of the payer based on a card number of a buyer (the payer), a social security number, or a phone number, and to manage the identification information of the payer.

The support fund automatic determination unit 320 may be configured to dynamically determine a support fund ratio provided to the buyer (the payer) and may determine the support fund ratio to the payment amount and transmit the support fund ratio to the support fund information processing unit 330.

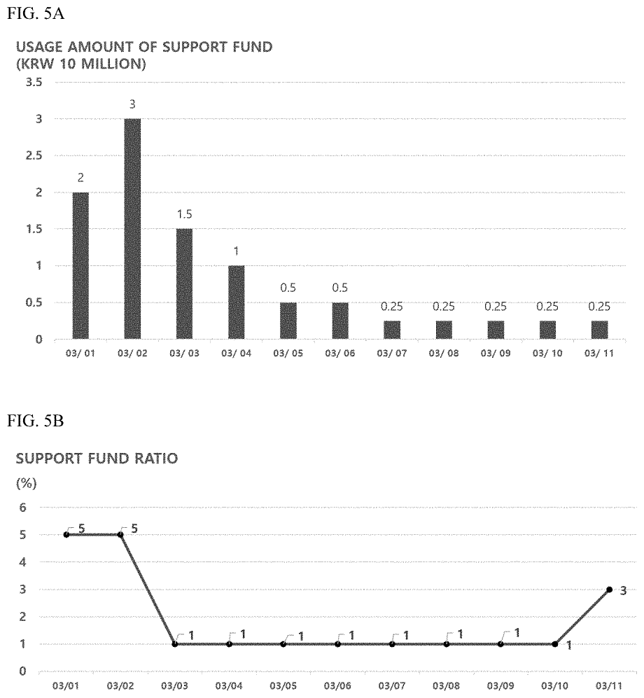

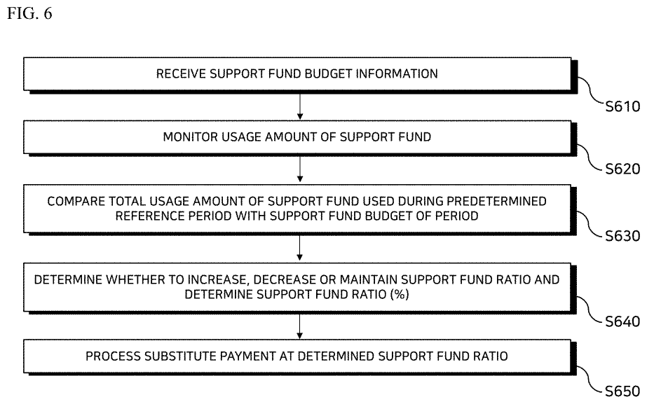

The support fund automatic determination unit 320 may be configured to determine the support fund ratio based on a support fund budget and an amount of use of the support fund, and compare the amount of use of the support fund for a predetermined period and the support fund budget during the period to determine whether to increase, decrease, or maintain the support fund ratio. Here, the predetermined period may be set on a daily, weekly, or monthly basis, and may be configured such that the predetermined period may be changed according to a ratio of exhaustion of the amount of use of the support fund to the support fund budget. For example, if the ratio of exhaustion of the amount of use of the support fund is high, the support fund automatic determination unit 320 may reduce the predetermined period to dynamically change the support fund ratio more quickly and slow down a budget exhaustion speed. On the contrary, because the ratio of exhaustion of the amount of use of the support fund is not high at the initial time of providing the support fund, the support fund automatic determination unit 320 may stably provide a fixed ratio of the support fund for a long period by increasing the predetermined period. A more specific example of the support fund ratio will be described with reference to FIGS. 5A and 5B.

In addition, the support fund automatic determination unit 320 may set a ratio of accumulation points or mileage to be provided to the payer relative to the payment amount in addition to the support fund. Accordingly, a substitute amount paid through the support fund may be provided to a user as a discount amount, and points or mileage for an additional payment amount may be provided.

In addition, the support fund information processing unit 330 may be configured to determine whether a support fund-based substitute payment condition is satisfied based on the payment information received from the payment and payment gateway server 200, and determine a substitute payment ratio based on the support fund ratio determined by the support fund automatic determination unit 320. Here, the determination of whether the substitute payment condition is satisfied may be performed based on at least one of the support fund limit of the payer (the buyer), a business type of the seller, purchase details, and a payment amount. If the payment information satisfies all these conditions, the support fund information processing unit 330 may provide split payment information to the payment and payment gateway server 200 so that a split payment may be possible between the payer and the support fund provider based on the previously set support fund ratio. If the payment information does not satisfy the substitute payment condition, the support fund information processing unit 330 may transmit that the substitute payment is impossible to the payment and payment gateway server 200, and process the substitute payment to be disapproved.

For example, if conditions such as a preset payment period, a payment amount per case, allowable purchase details, an allowable seller, and a business type of the allowable seller are not satisfied, the support fund information processing unit 330 may process to make it impossible to provide the support fund. In addition, the support fund information processing unit 330 may compare the payment amount with the support fund limit balance of the payer (the buyer), if there is no support fund limit balance, process to make the substitute payment impossible, or if the support fund limit balance is smaller than the total support fund amount according to the support fund ratio to the payment amount, process the split payment so that support fund processing is performed only on the support fund limit balance.

In addition, the payment information notification unit 340 may be configured to transmit support fund-based substitute payment information to the payer (the buyer). In addition, the payment information notification unit 340 may be configured to transmit support fund ratio information, support fund processing details, and support fund remaining limit information to a payer terminal after the substitute payment is completed.

In addition, the priority processing unit 350 may be configured to set and process a plurality of settings of the substitute payer including the support fund provider according to a payment priority. When a payment is requested to a first priority substitute payer according to substitute payment processing and when the substitute payment is disabled or rejected due to exceeding the limit, inability to pay, or intention to cancel the substitute payment, the priority processing unit 350 may be configured to set and execute the payment priority so that a next priority payment is performed by a second priority substitute payer set as the next priority. For example, when there are two substitute payers that the buyer set as the substitute payer, when a first priority substitute payment is set to a payer A and a second priority substitute payment is set to a payer B, and when a substitute payment of the payer A of the first priority substitute payment is impossible, the priority processing unit 350 may set the priority so that a substitute payment of the payer B who is the next priority is performed, thereby preventing a payment error and a payment inability through setting of the plurality of substitute payers.

In addition, a substitute payer such as the government, a local government, an association, a foundation, a donation organization, etc. irrespective of the mutual relationship setting is set as the priority substitute payment, and a previously registered substitute payer is set as a next priority substitute payment based on the relationship setting such as family, relative, or friend, when the buyer is a target of receiving support from the government, the local government, the association, the foundation, the donation organization, etc., the priority processing unit 350 may proceed the substitute payment as the priority, and when an insufficient payment amount exists, process the split payment to proceed through the previously registered substitute payer.

For example, the government, the local governments, the association, etc. may designate socially vulnerable class or disaster victims, etc., and the priority processing unit 350 may assign the first priority substitute payment to an institution substitute payer that performs the substitute payment, assign the second priority substitute payment to a donation related group substitute payer that supports a target that satisfies a specific condition or category such as a foundation, a donation group, a public trust, a donor, etc., and assign a third priority substitute payment to the previously registered substitute payer based on the relationship setting such as family, relative, and friend. In addition, in the case of a support class or s target designated by the government, the local government, etc., the priority processing unit 350 may sequentially apply the first, second, and third priority substitute payments to process the split payment.

FIGS. 5A and 5B are example diagrams for explaining a method of determining a support fund ratio in a support fund distribution system according to an embodiment of the present disclosure.

First, referring to FIG. 5A, a usage amount of support fund, for example, from March 1st to 11th is shown and assuming that a support fund providing period is, for example, 1 year, and an annual support fund budget is KRW 36.5 billion, an average daily support fund of about KRW 100 million may be provided. Here, if a predetermined reference period for determination of the support fund ratio is set to two days, the total amount of support fund used from March 1st to 2nd is KRW 500 million, and the average amount of support fund used during this period is KRW 250 million, and thus the support fund is executed exceeding KRW 150 million compared to the average daily budget of KRW 100 million.

Referring to FIG. 5B, according to the excessive execution of the support fund, an initial support fund ratio of 5% from March 3rd is reduced to 1%, and the usage amount of the support fund may be continuously monitored to determine the support fund ratio on the basis of two days.

Referring again to FIG. 5A, as the support fund ratio is reduce, it may be seen that the amount of support fund used by a buyer is gradually decreasing. For example, it may be seen that the total amount of support fund used from March 3rd to 4th is KRW 250 million, the total amount used from March 5th to 6th is KRW 100 million, the total amount used from March 7th to 8th is KRW 50 million, and the total amount used from March 9th to 10th is KRW 50 million. At this time, it may be seen that the total amount of support fund used from March 1st to 4th is KRW 750 million in which the support fund of a daily average of KRW 187.5 million is over-executed, the total amount of support fund used from March 1st to the 6th is KRW 850 million in which the support fund of a daily average of KRW about 141.7 million is over-executed, the total amount of support fund used from March 1st to 8th is KRW 900 million in which an over-execution ratio is quite reduced to the support fund of a daily average of KRW 1.125 million, and the total amount of support fund used from March 1st to 10th is KRW 950 million in which an under-execution is changed to the support fund of a daily average of KRW 95 million. Accordingly, referring to FIG. 5B, the support fund ratio may be increased from 1% to 3% on March 11 to increase the use of the support fund.

As described above, the substitute payment processing server 300 may dynamically change and apply the support fund ratio, and thus it will be possible to implement a support fund distribution system in which the budget may be evenly distributed throughout the entire period of a budget provision period through a demand-based determination of the dynamic support fund ratio.

FIG. 6 is a flowchart illustrating a method of distributing a support fund using a substitute payment processing server according to an embodiment of the present disclosure.

The substitute payment processing server 300 may receive support fund budget information, such as a support fund budget and a budget period (S610). When a budget is added due to an additional supplement, the substitute payment processing server 300 may update and reflect the support fund budget information in real time.

The substitute payment processing server 300 may monitor an amount of use of the support fund (S620). The substitute payment processing server 300 may calculate a remaining amount of the support fund by subtracting the amount of use of the support fund from the support fund budget.

Next, the substitute payment processing server 300 may compare the total amount of support fund used during a predetermined reference period with the support fund budget of the corresponding period (S630). For example, substitute payment processing server 300 may calculate an average amount of use of support fund based on a reference period set in units of one day, two days, weeks, months, etc., and compare an average support fund budget assigned during the period.

Next, the substitute payment processing server 300 may determine whether to increase, decrease, or maintain a support fund ratio and the support fund ratio (%) based on results of the above comparison (S640). If the average amount of support fund used during the set reference period exceeds an average support fund budget assigned during the period, the substitute payment processing server 300 may reduce the support fund ratio, and to the contrary, if the average amount of support fund used during the set reference period is smaller than the average support fund budget assigned during the period, the substitute payment processing server 300 may increase the support fund ratio, and if the average amount of support fund used during the set reference period is similar to the average support fund budget assigned during the period within a certain range, the substitute payment processing server 300 may maintain the support fund ratio. In addition, the substitute payment processing server 300 may adjust a variation range of the support fund ratio based on how large a difference between the average amount of support fund used during the set reference period and the average support fund budget assigned during the period is.

The substitute payment processing server 300 may provide the support fund through substitute payment processing at the determined support fund ratio (S650). Because the support fund ratio may vary every certain period, it is possible to distribute and use the support fund budget more efficiently and stably during the period through the application of the dynamically determined support fund ratio.

In the above, the support fund distribution system using a substitute payment according to the embodiments of the present disclosure have been described as specific various embodiments, but this is only an example, and the present disclosure is not limited thereto, and should be construed as having the widest scope according to the basic idea disclosed herein. Those skilled in the art may combine and replace the disclosed embodiments to implement a pattern having a shape that is not indicated, but this also does not depart from the scope of the present disclosure. In addition, those skilled in the art may easily change or modify the disclosed embodiments based on the present specification, and it is clear that such changes or modifications also belong to the scope of the present disclosure.

What is claimed is:

1. A substitute support fund distribution system using a substitute payment processing server, the substitute support fund distribution system comprising:
a payment request terminal configured to transmit information related to a seller and payment information related to a payer;
a payment and payment gateway server configured to receive a payment request from the payment request terminal and proceed with payment or remittance processing; and
the substitute payment processing server configured to communicate with the payment and payment gateway server, and transmit information about a support fund related to the payer to the payment and payment gateway server.

2. The substitute support fund distribution system of claim 1, wherein the payment and payment gateway server comprises at least one of a VAN company server, a PG company server, a card company server, and a financial company server.

3. The substitute support fund distribution system of claim 1, wherein the substitute payment processing server comprises a support fund automatic determination unit configured to determine a support fund ratio to a payment amount.

4. The substitute support fund distribution system of claim 3, wherein the support fund automatic determination unit is configured to determine the support fund ratio based on a support fund budget and a usage amount of the support fund.

5. The substitute support fund distribution system of claim 3, wherein the support fund automatic determination unit is configured to determine whether to increase, decrease, or maintain the support fund ratio by comparing a usage amount of the support fund during a predetermined period with a support fund budget during a period.

6. The substitute support fund distribution system of claim 5, wherein the predetermined period is settable on a daily, weekly, or monthly basis, and is changeable according to an exhaustion ratio of the usage amount of the support fund to the support fund budget.

7. The substitute support fund distribution system of claim 3, wherein the support fund automatic determination unit is configured to set a ratio of accumulation points to be provided to the payer based on a payment amount in addition to the support fund.

8. The substitute support fund distribution system of claim 3, further comprising a substitute payment information processing unit configured to determine whether a substitute payment condition is satisfied based on payment information received from the payment and payment gateway server, and to determine a substitute payment ratio based on the support fund ratio determined by the support fund automatic determination unit.

9. The substitute support fund distribution system of claim 8, wherein whether the substitute payment condition is satisfied is determined based on at least one of a support fund limit, a business type of the seller, purchase details, and a payment amount.

10. A substitute support fund distribution method using a substitute payment processing server, the substitute support fund distribution method comprising:
transmitting, by a payment request terminal, information related to a seller and payment information related to a payer;
receiving, by a payment and payment gateway server, a payment request from the payment request terminal and proceeding, by the payment and payment gateway server, with payment or remittance processing; and
communicating, by the substitute payment processing server, with the payment and payment gateway server, and transmitting, by the substitute payment processing server, information about a support fund related to the payer to the payment and payment gateway server.

11. The substitute support fund distribution method of claim 10, further comprising determining, by the substitute payment processing server, a support fund ratio to a payment amount.

12. The substitute support fund distribution method of claim 11, wherein the support fund ratio is determined based on a support fund budget and a usage amount of the support fund.

13. The substitute support fund distribution method of claim 11, further comprising determining, by the substitute payment processing server, whether to increase, decrease, or maintain the support fund ratio by comparing a usage amount of the support fund during a predetermined period with a support fund budget during the period.

14. The substitute support fund distribution method of claim 13, wherein the predetermined period is settable on a daily, weekly, or monthly basis, and is changeable according to an exhaustion ratio of the usage amount of the support fund to the support fund budget.

15. The substitute support fund distribution method of claim 11, further comprising setting a ratio of accumulation points to be provided to the payer based on a payment amount in addition to the support fund.

16. The substitute support fund distribution method of claim 11, further comprising determining whether a substitute payment condition is satisfied based on received payment information, wherein a substitute payment ratio is determined based on the determined support fund ratio.
